(19) United States
(12) Patent Application Publication
(10) Pub. No.: US 2006/0009338 A1
(43) Pub. Date: Jan. 12, 2006

(54) Apparatus and process for cups having a metallized/holographic PET film exterior

(76) Inventors: John Taylor Kirkpatrick, Clyde, NC (US); Andrew C. Sloan, Canton, NC (US)

Correspondence Address: J. Bennett Mullinax, LLC;Suite 206, 3447 Pelham Rd., P O Box 26029, Greenville, SC, 29616-1029, US

(21) Appl. No.: 10/889,501

(22) Filed: Jul. 12, 2004

(51) Int. Cl. B31B 1/90

(52) U.S. Cl. 493/104

(57) ABSTRACT

A paperboard cup is provided having a polyethylene terepthalate film exterior surface. An inner surface of the paperboard substrate has an extrusion applied polyolefin coating. The side seam region of the cup is heat sealed in association with a polyethylenimine primer layer present within the sealed area. The process and resulting cup provides for a side seam seal having excellent tear strength properties which may be formed using conventional cup-forming equipment and sealing processes. The PET film layer may define a metallized or holographic substrate which enables an improved appearance to the cup exterior.

### FIELD OF THE INVENTION

This invention is directed toward a disposable paper cup suitable for serving hot or cold food products and beverages. The invention is further directed to a disposable paperboard cup having a metallized or holographic film applied to an exterior of the cup.

### BACKGROUND OF THE INVENTION

Disposable, single-use paperboard cups are widely known and used in the industry. The external graphics associated with disposable cups are of great interest in many foodservice and specialty industries. For instance, birthday novelty cups, fast food promotional cups, themed movie theater cups, and other special marketing cups may be directed to various entertainment, sports, or other promotional uses. The ability to provide a premium, high visual impact cup product is of great interest within the industry.

Frequently, specialized theme paper cups are manufactured having enhanced exterior graphics directed to an advertising promotion or seasonal holiday or event. Often, the exterior graphics or other promotional information is printed onto an exterior board stock which is used to form the sidewalls of the cup. The printed board stock is compatible with conventional heat sealing techniques which are used to form the side seams and/or bottom seams of the cup.

Holographic and metallized films have been used in some packaging arts to bring about enhanced aesthetics and designs for packaging. However, the film layers which support the holographic or metallized substrates are not readily compatible with existing cup forming processes. Accordingly, there remains room for variation and improvement within the art.

### SUMMARY OF THE INVENTION

It is one aspect of at least one of the present embodiments to provide for a process for manufacturing a paperboard cup and the resulting cup product in which the exterior of the finished cup comprises a holographic or metallized film layer.

It is a further aspect of at least one of the present embodiments to provide for a disposable cup having an outer layer formed by a polyethylene terepthalate (PET) film substrate supporting a metallized or holographic image(s).

It is yet a further aspect of at least one of the present embodiments to provide for a board substrate having opposite surfaces of LDPE applied to the paperboard substrate. Opposite one side of the LDPE coated board, a metallized or holographic film is applied with the metal or holographic image material adjacent the LDPE layer. The outer film layer comprised of PET may optionally have applied along one edge an effective amount of a polyethylenimine (PEI) primer, the primer facilitating the formation of the wall seam along a side of the cup.

It is yet another aspect of at least one embodiment of the present invention to provide for a process of making a cup comprising the steps of supplying a board substrate, the board substrate having on an exterior surface an ornamental film comprising an outermost layer of PET; forming the cup stock material into a frustoconical shape; and, applying to an edge portion of the frustoconical substrate an effective amount of a PEI primer to the PET layer. Following application of the primer to the PET surface, the PET surface and an adjacent layer of a polyolefin may be heat sealed to form a side seam of a cup using conventional equipment and heat sealing temperatures.

It is yet a further aspect of at least one embodiment of the present invention to provide for a paper cup structure having an exterior surface of a metallized/holographic PET film applied to a two-sided polycoated paperboard. A side seam of the cup where the polycoated paperboard is in contact with an exterior PET layer has a polyethylenimine primer applied at the seal area at a coating weight of between about 0.02 to about 0.08 dry pounds/ream.

It is yet a further and more particular aspect of at least one embodiment of the present invention to provide for paperboard cup blanks using a double-sided, coated polyolefin board having an exterior PET film layer with a metallized and/or holographic surface adjacent a polyolefin layer of the coated board. A dried coating of a PEI primer of between about 0.02 to about 0.08 dry pounds/ream is applied only to the seam area of the outer PET layer, the PEI primer facilitating bonding between a PET based, metallized film layer and an adjacent polyolefin layer.

These and other features, aspects, and advantages of the present invention will become better understood with reference to the following description and appended claims.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 is a perspective view of one embodiment of a paperboard cup that may be constructed according to the present invention;

FIG. 2 is a schematic representation of a bottom blank and a sidewall blank which may be combined to form the cup seen in FIG. 1;

FIG. 3 is a cross-section view showing the areas of the sidewall blank seams and additionally showing the joining of the sidewall blank to the bottom blank, thereby forming the cup shown in FIG. 1; and,

FIG. 4 is a cross-section through a coated board laminated structure showing the respective layers of paperboard substrate that may be used to provide sidewall blanks for use in accordance with the present invention.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

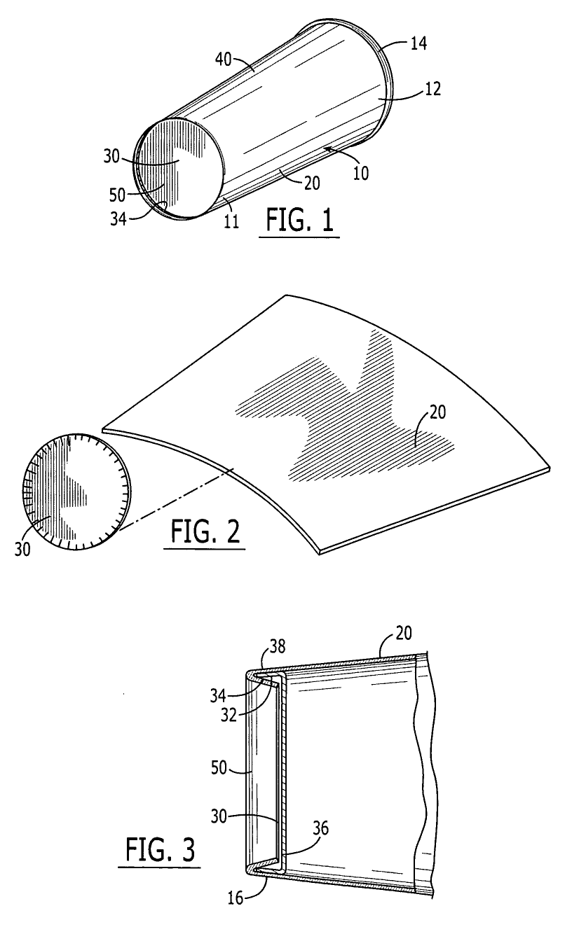

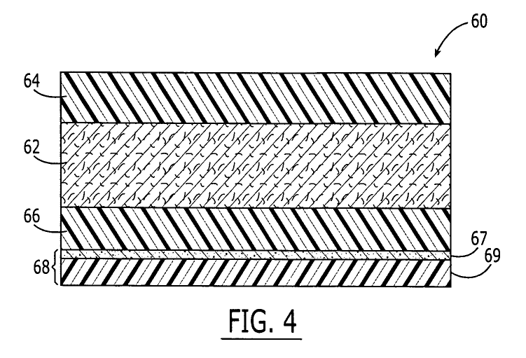

In reference to FIGS. 1 through 4, an exemplary paperboard cup 10 (FIG. 1) may be provided using the substrate 60 (FIG. 4). The substrate 60 and process described below provide for an improved paperboard cup which has a printable exterior surface of a PET film. In accordance with this present invention, a process and resulting cup is provided having improved graphics capability and which may be made using conventional cup-making equipment and techniques.

As best seen in reference to FIGS. 1 through 3, exemplary cup 10 includes an upper region 12 having a curled rim 14 and a bottom region 16. Cup 10 is made from a sidewall blank 20 which is wrapped around a bottom blank 30 (FIG. 2) and which is disposed generally transverse thereto. The bottom blank 30 is typically bent or folded over in proximity to its outer edge to form a lip 32 as best seen in reference to FIG. 3. The sidewall blank 20, formed of substrate 60 as seen in FIG. 4, is located with respect to bottom blank 30 so that a flap portion 34 having a bottom edge 36 extends beyond lip 32. Flap portion 34 is bent or folded around bottom edge 36 so that lip 32 may be squeezed between flap portion 34 and a lower region 38 of sidewall blank 20.

A typical cup 10 is made from a paperboard blank having thermoplastic polyolefin coatings such as low density polyethylene (LDPC) or other polyolefin. The thermoplastic material permits heat sealing of adjacent components. For instance, when sidewall blank 20 is wrapped around bottom blank 30, the adjacent edges are heated and pressed together along a seal 40. Similarly, lip 32, flap portion 34, and lower region 38 of sidewall blank 20 may be heated and pressed together at a typical cup bottom finishing station to form a strong, leak-proof bottom region 16. By forming cup 10 as illustrated in FIG. 3, a recessed area 50 is created in the bottom of cup 10 on an opposite side of bottom blank 30 from the main container region of cup 10. The recessed area 50 permits insertion of a tool to press lip 32 and flap portion 34 toward the lower region 38 of a sidewall blank 20. Suitable apparatuses and processes for providing a paper cup using a coated paperboard substrate may be found in reference to U.S. Pat. Nos. 5,556,364; 5,569,143; and 5,572,907 and which are incorporated herein by reference.

As best seen in reference to FIG. 4, the substrate 60 comprises a paperboard layer 62 such as a paperboard having a basis weight of between about 110 to about 233 pounds per 3,000 sq. ft., and which is coated on both sides of the board with respective polyolefin layers 64 and 66. A 7.2 pound LDPE in layer 64 and 10.8 pound LDPE in layer 66 has been found useful for manufacturing cups 10. LDPE layer 66 has applied thereto a film layer 68 which may be either a metallized or holographic film. As seen in reference to FIG. 4, holographic film 68 has an outer surface 69 of PET, an inner surface of which defines the metallized substrate layer 67.

The metallized substrate layer 67 provides for high visibility graphics such as holographic images which are visible through the associated PET material 69.

One source of a holographic or metallized film 68 which has been found useful in this invention includes PET films obtained from Spectratek (Los Angeles, Calif.). Various holographic and metallized PET films have been evaluated from Spectratek and have been found useful in accordance with this invention. The metallized substrate of the PET film layer may take on numerous shapes and aesthetic qualities including holographic images. For instance, customized PET film layers can be provided in which all of the graphic components for the resulting cup are set forth within the PET film. In addition, the exterior surface of the PET film may be subsequently printed with appropriate graphics or other information to suit the intended end use of the cup product.

The substrate 60 may be die cut to form the resulting cup sidewall having a frustoconical shape as seen in reference to FIG. 2. The sidewall blank 20 is adhesively joined opposite the marginal end portions of the sidewall blank 20 to provide an overlapping face-to-face relationship to form seam 40, as seen in FIG. 1, which extends longitudinally along the sidewall. The upper end portion of sidewall 20 is rolled or curled outwardly, thereby forming an annular rim 14 at the upper end of the sidewall and defining the circular opening of the upper end of the cup 10.

The circular bottom blank 30 is formed from a paperboard substrate which may be single coated or double coated with polyolefin layer(s) such as low density polyethylene. As described above in reference to FIG. 3, the bottom blank 30 is heated and pressed together along an overlapping folded bottom edge of sidewall 20 to form the recessed bottom region 16.

In accordance with the present invention, the use of a holographic film layer 68 allows a disposable cup construction which may offer enhanced graphics and aesthetics. The use of a PET metallized or holographic film layer 68 will not readily heat seal to an overlapping LDPE layer. In accordance with this invention, it has been found that an aqueous PEI primer such as the Mica brand A-131-X (Mica Corp., Shelton, Conn.) may be used to increase the bond strength between the adjacent PET surface and the LDPE surface. Absent a primer such as the PEI primer referenced above, conventional heat sealing temperatures and time intervals preferred by cup manufacturers will not provide an adequate strength seal between the overlapping edges of a wall blank 20 formed from substrate 60.

Further, it has been found that the PEI primer may be applied to the PET surface corresponding to the sidewall seam area to be formed by seam 40. As such, the entire substrate material does not require coating with the PEI primer. The application of the PEI primer may include techniques such as in register applications to the seal area with gravure or flexo printing techniques or applied to the seal area with a wick-type applicator on the cup-forming equipment. The applied PEI primer is typically dried using either flame, hot air, infrared radiation, or similar techniques. The application of heat helps activate the primer which increases its effectiveness in forming a desirable seal between the PET and the polyolefin.

Application of the primer to the PET film layer may be enhanced by incorporating sufficient isopropyl alcohol in order to achieve an appropriate wet-out of the primer. Following application and drying of the primer, the coated and primed substrate may be stored for several weeks at ambient conditions or immediately processed on cup-forming equipment.

Formation of the seams 40 using the primed substrate are made with a heat seal dwell time of approximately 0.25 second and using a heat seal temperature window of between about 600° F. to about 1000° F. The 0.25 second dwell time was found adequate to form a seal through both layers of the overlapping board substrate. Following formation of the cups, conventional leak tests using hot coffee were performed to determine adequacy of the side seam seal 40 along with the integrity of the bottom seam of the cup. Additionally, side seam 40 was manually opened. Satisfactory side seams were evaluated where full fiber tear occurred along the seam area. The PEI primer A-131-X obtained from Mica Corporation performed better than other evaluated primers. Such Mica primers as H-722, G-1092, M-1164, A-251-A, and R-361 did not provide, for the materials tested, the desired seal strength that was obtained with the A-131-X primer.

In addition to the enhanced aesthetic appearance of the resulting cups, the inclusion of the PET metallized film layer brings about additional improvements to the overall cup. For instance, the PET film layer provides a durable moisture barrier to the cup exterior. The moisture barrier properties of the PET film improve the durability of the cup with respect to external moisture such as “sweating” associated with cold beverages or in humid or moist conditions where an exterior of the cup may become wet. The PET film layer provides an improved barrier to the cup exterior against moisture. As a result, it is possible to provide a cup stock having a reduced thickness of polyolefin along an exterior side of the board.

In the illustrated embodiment, it is seen that the PET layer provides an outermost surface to the substrate and resulting cup blanks. The PET layer has a sufficiently low coefficient of friction to facilitate the mechanized handling and feeding of the respective substrate and blanks. Further, the PET exterior provides a surface which can be readily printed so as to provide additional graphics, logos, or other printed images to the PET surface.

It is also believed that the use of metallized and/or holographic PET films offer advantages in the formation of a liquid tight bottom seal. As described above, formation of the bottom seal does not involve the direct sealing of a PET layer to a polyethylene layer. Instead, the cup blank is folded such that the inner surface of the blank is used to engage the perimeter of the bottom blank 30. It is believed that the presence of a metallic substrate within the PET layer provides an improved seam against leakage. The heat conductive, metallized substrate found within the PET film layer is believed to provide better heat transfer through the bottom seam region, thereby contributing to improved cup performance and durability as a result of better thermoformed seams.

Use of the PET film layer is also beneficial in the formation of the curled rim 14 seen in reference to FIG. 1. The PET layer is easily rolled to form the curled edge 14. Further, the PET film is resistant to formation of cracks and tears and provides an excellent barrier layer within the curled edge 14. For reasons similar to those described in formation of the bottom seal, the PET film with metallized substrate brings about a rapidly formed, curled rim having excellent seal integrity.

The resulting cups having a side seam comprising a PEI primer positioned between the PET layer and the overlapping polyolefin layer of the coated board substrate provide for paperboard cups which may be easily nested into sleeved stacks. The PET exterior film surface is FDA approved for food contact. While in a normal operation of the cup, there is no PET contact area with liquid contents, paperboard cups are commonly stacked in a nested arrangement. Accordingly, it is prudent to make certain that the cup exterior, which nests with an interior surface of an adjacent stacked cup, provides for no opportunity for transfer of unsuitable materials. Evaluations of the cups indicate that there is no detectable PEI primer present on the exterior of the cups when manufactured as described herein.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole, or in part. Therefore, the spirit and scope of the appended claims should not be limited to the description of the preferred versions contained therein.

1. (canceled)

2. (canceled)

3. (canceled)

4. (canceled)

5. (canceled)

6. A process of providing a paperboard cup comprising:
providing a paperboard having a first surface and a second surface of an LDPE extrusion layer;
applying to an outer surface of said paperboard substrate a PET film layer;
applying to a side seam forming area of said PET film layer an effective amount of a PEI primer;
overlapping said PET film layer containing said PEI primer with a side seam forming area of said inner surface of said paperboard substrate;
forming a heat sealed seam by the application of heat and pressure;
providing a bottom blank; and,
joining the bottom blank to said sidewall blank, thereby forming a paperboard cup having an outer surface of PET film.

7. The process according to claim 6 wherein said PET film layer further comprises an inner surface having a metallized region defined therein.

8. The process according to claim 7 wherein said metallized region further defines a holographic image.
